(19) United States
(12) Patent Application Publication
(10) Pub. No.: US 2023/0167388 A1
(43) Pub. Date: Jun. 1, 2023

(54) SYSTEM FOR ACCELERATING THE AGING OF BEER AND METHOD OF USE THEREOF

(71) Applicant: BrewSonic Inc., Montreal (CA)

(72) Inventors: Hugo Pizon, Montreal (CA); Mathieu Dionne, Mirabel (CA); Charles Desormiers, Mirabel (CA); Elorn Hamon, Montreal (CA)

(21) Appl. No.: 18/056,094

(22) Filed: Nov. 16, 2022

Related U.S. Application Data
(60) Provisional application No. 63/283,394, filed on Nov. 26, 2021.

(51) Int. Cl. C12C 11/11

(52) U.S. Cl. CPC C12C 11/11

(57) ABSTRACT

A method for accelerating aging of beer in order to enhance one or more flavors that are exhibited by the beer; it includes providing in a recipient beer with one or more materials to impart flavor to the beer during an aging process, the recipient joined to one or more ultrasonic transducers; generating ultrasound that travel into the beer using the one or more ultrasonic transducers in order to disrupt the one or more materials contained in the beer, thereby imbuing the beer with one or more flavors corresponding to the one or more materials; and extracting the flavored beer from the recipient for bottling, whereby the bottled beer is carbonized.

The present application claims priority from U.S. provisional patent application No. 63/283,394 filed on Nov. 26, 2021, incorporated herein by reference.

### TECHNICAL FIELD

The present disclosure relates to production of alcoholic beverages, and more particularly to the aging of beer during beer production.

### BACKGROUND

The general beer production process begins with brewing. Water is heated.

Grains, hop and yeast are steeped. The liquid is then extracted and allowed to ferment for several weeks. Following the fermentation, the beer is filtered (e.g. the filtration may be coarse or more fine to remove respectively larger or smaller particulates that can affect the final product) and carbonized, either naturally (e.g. by adding sugar) or through forced addition of carbon dioxide (e.g. with CO₂ gas for keg) after the beer has been added to a bottle, can or keg.

To add taste to the beer, between the fermentation and filtration steps, the beer may be aged for a week to up to several years, depending on the recipe, with wood, fruits, flower, hop or any organic matter which can add taste. These materials are added to the liquid, and sit in the liquid for a given period, the taste from these materials transferring over to the beer as a result of the exposure of the materials to the liquid over time.

However, it will be understood that an aging period of one week to several years is a long time for beer, especially considering that beer has a natural shelf life and will go foul generally faster than liquor if left unconsumed for a prolonged period (where generally the shelf life of beer is related to its alcohol content, where often times a higher alcohol content signifies a longer shelf life). As such, the aging process of beer, even though it adds flavour to the beer, undercuts the shelf life of same.

Moreover, as the beer ages, it cannot be consumed. This prolonged period increases cost of beer production, occupying valuable equipment such as barrels and vats as the beer sits in these containers. As this equipment is occupied by the aging beer, the equipment cannot be used to produce further beer, thereby causing a bottleneck in the beer production process.

Moreover, as beer is aged, the prolonged exposure to the added materials may also increase the risk of contamination due to the storage conditions and the long waiting time. This can lead to undesirable waste, and possibly to manufacturer liability if the contaminated beer has a negative effect on one of its consumers.

Therefore, identifying a method to accelerate the aging of the beer would be advantageous.

### SUMMARY

The present disclosure relates to the application of ultrasound to the container in which is found the fermented beer. The ultrasound disrupts the materials present in the fermented beer, thereby causing particles from the materials to detach from the materials and mix with the beer. This enhances the flavour of the beer. As a result, the aging process of the beer can be diminished to less than several hours, as the flavour is imparted from the materials at a quicker rate due to the action of the ultrasound on the materials.

The beer may be filtered before or after the aging, where the filtration can be a coarser filtration in order to remove larger particles, or a finer filtration. The filtration may also involve the removal of yeast by-products or yeast cells that accumulate at the top of the beer product.

A broad aspect is a method for accelerating aging of beer in order to enhance one or more flavors that are exhibited by the beer, including providing in a recipient degassed fermented beer with one or more materials to impart flavor to the beer during an aging process, the recipient joined to one or more ultrasonic transducers; generating ultrasound that travel into the fermented beer using the one or more ultrasonic transducers in order to disrupt the one or more materials contained in the beer, thereby imbuing the beer with one or more flavors corresponding to the one or more materials; and extracting the flavored beer from the recipient for bottling, whereby the bottled beer is carbonized.

In some embodiments, the ultrasound may be generated at a frequency of 20 kHz-80 kHz.

In some embodiments, the one or more transducers may include transducers that are inserted into the recipient and protected with a waterproof barrier.

In some embodiments, the one or more transducers may include transducers that are joined to an exterior surface of a wall of the recipient, in direct contact with the wall of the recipient.

In some embodiments, the method may include carbonating the aged beer.

In some embodiments, the one or more materials may include wood.

In some embodiments, the one or more materials may include fruit.

In some embodiments, the method may include introducing oxygen into the fermented beer while the ultrasound is generated to promote micro-oxidation.

In some embodiments, the air may be introduced into the fermented beer by disturbing the fermented beer.

In some embodiments, the method may include, after the generating, filtering the beer to remove solids.

Another broad aspect is beer that has been aged using the method as defined herein.

Another broad aspect is a method for accelerating aging of beer in order to enhance one or more flavors that are exhibited by the beer, comprising generating ultrasound that travel into fermented beer in order to disrupt one or more materials contained in the beer, thereby imbuing the beer with one or more flavors corresponding to the one or more materials.

Another broad aspect is a system for accelerating aging of beer in order to enhance one or more flavors that are exhibited by the beer. The system one or more ultrasonics transducers for generating ultrasound that travel into fermented beer for disrupting one or more materials contained in the beer, thereby imbuing the beer with one or more flavors corresponding to the one or more materials; and a controller configured to generate alternating current that is converted by the one or more ultrasonic transducers into the ultrasound at a given frequency.

In some embodiments, the system may include a recipient for receiving the fermented beer.

In some embodiments, the recipient may be a vat.

In some embodiments, a user input interface for receiving input to start or stop the generating of ultrasound when the input may be received by the controller.

### BRIEF DESCRIPTION OF THE DRAWINGS

The invention will be better understood by way of the following detailed description of embodiments of the invention with reference to the appended drawings, in which:

FIG. 1 is a block diagram of an exemplary system for accelerating the aging of beer;

FIG. 2 is a flowchart diagram of an exemplary method of accelerating the aging of beer; and

FIG. 3 is a block diagram of an exemplary system for accelerating the aging of beer.

### DETAILED DESCRIPTION

The present disclosure relates to a system and method for accelerating the aging process of beer through the use of ultrasound, propagated through the aging beer. The ultrasound interacts with the materials added to the beer, disrupting their structure, thereby dislodging particles that in turn mix with the beer. The force applied by the ultrasound results in an increased transfer of the flavours to the beer. Moreover, unlike with other forms of liquor, the fermentation process that results in beer involves yeast cells. During aging, residual fermentation still occurs as a result of the present yeast cells. As a result, a consideration was if the application of ultrasound would disrupt significantly the yeast cells, affecting the remaining fermentation process. It would appear that the frequencies of ultrasound applied, as described herein, do not affect, at least significantly, the yeast cells. Therefore, ultrasound waves are appropriate for enhancing the aging of beer, without altering negatively the integrity of the beer.

Moreover, as liquor production involves distillate aging, these liquors do not include residual materials that are found within the liquid that could disturb the liquid during the aging process. Unlike liquors, beer does not involve residual extraction. The yeast found inside the beer allows the beer to undergo carbonation of the beer, after the bottling, to achieve a sparkling beverage. Furthermore, unlike beer that has a low alcohol content, the high alcohol content of liquor reduces the risk of contamination. As such, accelerated aging of beer is further sought in order to reduce the risk of contamination that is minimal during the aging process of liquors.

The ultrasound-based beer-aging method involves the use of ultrasonic waves propagated through the beer, resulting in cavitation of the beer, where the vapor-filled cavities in the liquid are created by the cavitation cause the wearing of the added materials, thereby extracting the organic matter of the added materials, resulting in a faster aging process than a classic aging method.

In the present disclosure, by “one or more materials” or “materials”, it is meant the items that are added to the beer to confer to the beer flavours (such as imparted by aromas) that are attributable to these items. For instance, exemplary materials include, but are not limited to, wood, liquor-imbued wood, hop, fruit such as strawberries, raspberries, apples, chocolate, vanilla, flowers, fine herbs, spices such as cinnamon, nutmeg, etc.

### Exemplary System for Aging Beer

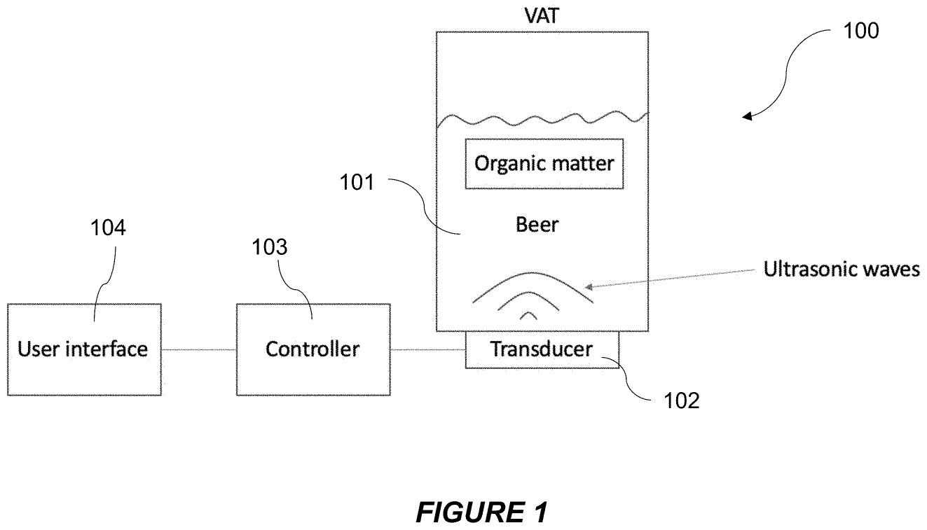

Reference is now made to FIG. 1, illustrating an exemplary system 100 for aging beer. The ultrasonic aging system 100 includes one or more transducers 102, a recipient 101 for receiving the beer, a controller 103. The system may include a user input interface 104.

The one or more transducers 102 may be fixed on the outer surface of recipient 101. In some embodiments, the one or more transducers 102 may be positioned in the recipient 101 (e.g. may be attached to an inner surface of the wall of the recipient 101, or may be joined to a module that is lowered through an opening of the recipient 101 into the beer—the inner compartment of the recipient 101). As the one or more transducers 102 are introduced into the beer or will be in direct contact with the beer, a waterproof coating or casing may encase the one or more transducers 102, protecting the one or more transducers 102 from damage caused by the beer.

The one or more ultrasonic transducers 102 convert alternating electric signal to ultrasonic waves that propagate through the recipient 101 through the beer.

The controller 103 is configured to cause the one or more transducers 102 to generate ultrasound at a given frequency. For instance, the controller 103 may include one or more of a processor (e.g. microprocessor), memory for storing program code therein, and an oscillator, where the oscillator generates from direct current alternating current at a desired frequency, that is then converted by the transducer into ultrasound at a given frequency corresponding to the alternating current.

The recipient 101 contains the beer to be aged and the materials to impart flavour to the beer during the aging. Exemplary recipients 101 include, but are not limited to, vats, barrels, reservoirs, etc. The recipient 101 may be made from metal, from wood, etc. The recipient 101 may include a stand for providing support to the recipient while resting on a surface, such as a floor, or for anchoring to a ceiling or wall. The volume of the recipient 101 may vary without departing from the present teachings.

The user input interface 104 enables a user to manage the one or more transducers (e.g. adjust the frequency of the ultrasound by sending input to the control), start and/or stop the ultrasound produced by the one or more transducers 102, set a timer for the generation of ultrasound, etc. The user input interface 104 may be one or more buttons, a keyboard, a mouse, a touchscreen, a microphone, etc.

In some examples, the system 100 may also include a display for, e.g., sharing with a user information on the aging process (e.g. frequency of the ultrasound produced, the time elapsed since the beginning of the aging process, the temperature of the fermented beer, etc.)

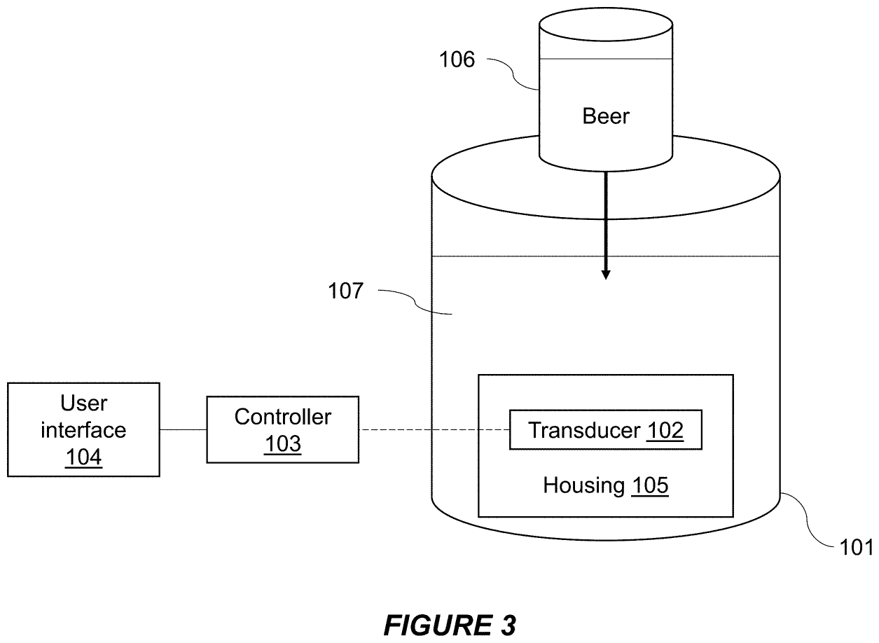

In some embodiments, as illustrated in FIG. 3, the recipient 101 may receive a sub-recipient 106 that contains the beer, resulting in the recipient 101 containing the beer. Once the recipient 101 has received the sub-recipient 106, the recipient 101 and the sub-recipient 106 define a space. The space is occupied by a medium 107, surrounding at least partially the sub-recipient 106, that enables the propagation of ultrasound therethrough generated by the one or more transducers 102. Exemplary mediums 107 may be, but are not limited to, water, acetone, a glycol, etc. The one or more ultrasonic transducers 102 may be located on the outer wall of the recipient 101, or found in the medium 107 (where the one or more transducers may be contained in a sealed housing or casing 105—multiple transducers 102 per housing or casing 105, or one transducer 102 per housing or casing 105—, preventing the medium 107 from seeping therein and damaging the one or more ultrasonic transducers 102).

In these embodiments, the sub-recipient 106 may be a vat, a keg (the keg may be composed on metal, wood, etc.) The sub-recipient 106 may be made from a material (e.g. wood) that would contribute to the accelerated aging of the beer once subject to the ultrasound produced by the one or more ultrasonic transducers 102. The use of a keg may be when an initial vat containing the beer has a volume that is too large to fit into the recipient 101, and would therefore require subdividing the volume of beer into smaller recipients, the kegs, before immersing the kegs into the medium contained in the recipient 101.

In these embodiments, the use of sub-recipients 106 enables a reduction in the volume of the beer that is subject to the ultrasound treatment per treatment, thereby increasing the amount of ultrasound that interacts with the contained beer. This focused targeting with ultrasound in the sub-recipient 106 can further accelerate the aging of beer.

### Exemplary Method of Accelerating the Aging of Beer

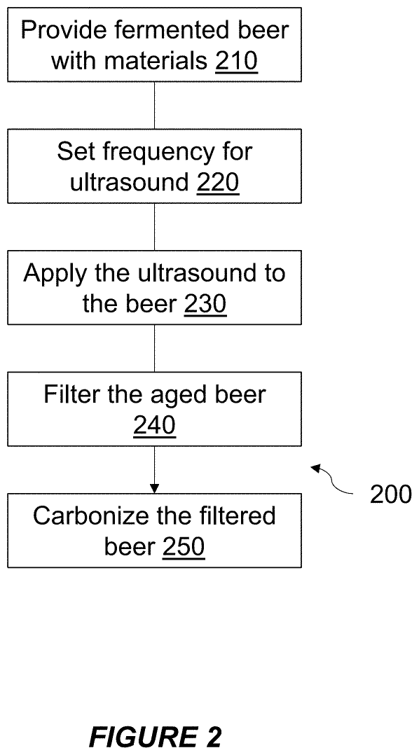

Reference is now made to FIG. 2, illustrating an exemplary method 200 for accelerating the again of beer. For illustrative purposes, reference will be made to system 100. However, it will be understood that the method 200 may be performed in association with other systems in accordance with the present teachings.

Beer (e.g. fermented beer. The beer will be referred to herein to fermented beer for illustrative purposes) is provided at step 210 (e.g. in a recipient 101 for aging). Materials for imparting flavour to the beer are added to the fermented beer. The beer may be degassed, or the recipient 101 may also for the fermented beer to be degassed in order to not build up pressure within the recipient 101.

The frequency of the ultrasound to be generated may be set at step 220. For instance, the oscillator of the controller 103 may be adjusted to produce an alternating current for generating, by the transducer, the ultrasound at the desired frequency. In some examples, a user may provide input, transmitted to and received by the controller 103, for setting the frequency of the transducer. For instance, the ultrasound may be generated at a frequency ranging anywhere from 20 kHz to 120 kHz, in some examples at 40 kHz, but it will be understood that a higher frequency may be used in certain contexts.

The ultrasound is then generated by the one or more ultrasound transducers 102 at step 230. The one or more transducers 102 are positioned in such a manner that there is no air between the transducer 102 and the beer (e.g. positioned in a waterproof casing and lowered into the beer; joined to the outer surface of the wall of the recipient such that the transducer makes direct contact with the wall such that no air separates the transducer from the wall, the inner surface of the wall in direct contact with the beer). The ultrasound may be generated fora period, e.g., between 10 minutes and 1 hour. The time during which the ultrasound is applied to the beer may depend on a given recipe (e.g. the nature of the materials contained in the beer, the intensity of the flavour of the materials to be imparted to the beer, the volume of the beer contained in the recipient, the dimensions of the recipient, the number of transducers generating the ultrasound, etc.) However, the use of ultrasound to accelerate the incorporation of flavour from the one or more materials to the beer results in at least a 100-fold reduction in the time required for adequate aging, where weeks or even a year can be reduced to one or a few hours. Moreover, the use of ultrasound does not disrupt the integrity of the unfiltered beer.

In some examples, concurrently with the aging, if the beer has already been carbonated, the beer that is subject to the ultrasound treatment may be mixed, or disturbed (e.g. shaken, mixed, stirred, etc.) to degas the beer during the aging process.

An incorporation of a small quantified amount of air or oxygen into the liquid may stimulate micro-oxidation, for further pronouncing certain of the flavours of the beer (e.g. imbuing the beer with a richness conferred by a small amount of oxidation of the beer, such as the one experienced by beer traditionally aged in a barrel). In some examples, the air or oxygen may be injected into the beer that is subject to ultrasound to achieve the oxidation-based flavour. It will be understood that if too much oxygen and/or air is added to the beer, it may cause too much oxidation which may result in spoiling of the beer.

Once the beer has been sufficiently aged, i.e., the flavour of the one or more materials has been sufficiently imparted to the beer, the aged beer is then filtered at step 240. The filtering (e.g. coarse or fine) is to remove at least some impurities or solids from the beer (e.g. remaining materials that were added to the fermented beer, remaining grains that were subject to fermentation, etc.)

The beer may be carbonized at step 250 (e.g. through the addition of sugars, by applying pressurized carbon dioxide, etc.)

In some embodiments, the aged beer may be recirculated in a beer production system in order to repeat certain of the steps associated with the production of the beer (e.g. an additional fermentation step following the aging of the beer).

### Exemplary Studies

The following exemplary studies are provided to enable the skilled person to better understand the present disclosure. As they are but illustrative and representative examples, they should not limit the scope of the present disclosure, only added for illustrative and representative purposes. It will be understood that other exemplary studies may be used to further illustrate and represent the present disclosure without departing from the present teachings.

### Exemplary Study 1

The following materials are provided: 30 L of unaged beer is provided in a pressurized keg, 9 L of 6 months aged beer is contained in a wood bourbon barrel, 1 cleaning machine for the keg, a transfer valve system to conduct beer from one keg to another, 2 empty kegs of 50 L, 1 bottle of pressurized CO₂, 1 ultrasonic aging beer system, 24 voltage direct current power supply, 5 volt direct current power supply, an extension cord, a screwdriver, and some food sanitizing product.

First, any materials in direct contact with the liquid is sanitized. The keg is cleaned with a cleaning machine. Then, 10 g of wood chips that have be soaked in bourbon are prepared. The wood chips are added into the vat of the ultrasonic aging system. 12 L of non-aged beer is transferred inside one empty keg. Carbonates are removed from the keg. The beer is transferred into the ultrasonic aging system. Aging is performed for 1 hour. The aged beer is then transferred from the ultrasonic aging system to another empty keg.

### Exemplary Study 2

3 samples are compared to ascertain the efficacy of the aging process performed by the ultrasound aging system, the results of which are detailed in Table 1. 12 L of aged beer using the ultrasonic method, 18 L of non-aged beer and 9 L of aged beer using a classic method in a wood barrel, as in known in the art, are compared. The aged beer has been provided by a beer manufacturer that specializes in traditional beer aging.

TABLE 1
results from a comparison of different properties between
the unaged beer, the beer aged using a traditional method,
and the beer aged using the ultrasound method.

| Cri- | | aged in | aged by | Expert | Expert |
|---|---|---|---|---|---|
| teria | non-aged | barrel | ultrasound | comment 1 | comment 2 |
| Color | Black | Black | Black | Aging does | Aging does |
| | | | | not change | not change |
| | | | | color of | color of |
| | | | | liquid | liquid |
| Smell | Chocolate, | Chocolate, | Chocolate, | smell | smell |
| | coffee | wood, | young | changed, | changed, |
| | | liquors | wood, | difference | difference |
| | | | slight | is apparent | is apparent |
| | | | liquors | on each | in each |
| | | | taste | sample | sample |
| Taste | bitter, | bitter, | bitter, | Taste more | Similar |
| | chocolate | chocolate, | chocolate, | pronounced | taste between |
| | | power | slightly | than unaged | traditionally |
| | | brought by | woody | beer | aged beer and |
| | | bourbon | | | ultrasound- |
| | | and wood | | | aged beer. |
| | | | | | Micro-oxida- |
| | | | | | tion missing |
| | | | | | from ultra- |
| | | | | | sound-aged |
| | | | | | beer due to |
| | | | | | the air |
| | | | | | missing across |
| | | | | | the wood bar- |
| | | | | | rel, resulting |
| | | | | | in less strik- |
| | | | | | ing flavour |
| | | | | | than with the |
| | | | | | traditional |
| | | | | | method. |

### Exemplary Study 3

The results found in Table 1 are discussed herein. The smell between the different forms of beer were compared. The non-aged beer had coffee and chocolate flavors. The beer aged using ultrasound had a slight but apparent wood smell and a slight liquor smell. The beer that was aged using the classic method smelled of wood and liquor. The taste between the samples were different. However, the taste of the beer using the ultrasound technique was far closer to the taste of the traditionally aged beer, where the differences were slight and attributable to minor differences in the materials used for the aging that were barely noticeable to the taster, than to the taste of the unaged beer. More specifically, the unaged beer was bitter and tasted of chocolate. However, the beer that was aged using ultrasound had a pronounced wood flavor, absent from the unaged beer. Moreover, the bitterness of the unaged beer was practically undetectable in the sample that was aged using ultrasound. However, the beer that had been aged using the traditional method had a stronger flavor brought by liquor, as well as the wood flavor that was equally found in the ultrasound-aged beer, and a tiny oxidation flavor that was absent from the ultrasound aged beer. It will be appreciated that increasing the exposure of the beer by one or more hours to the ultrasound may result in a heightened set of flavours imparted by the one or more materials.

Therefore, the beer that had been aged used the ultrasound-based technique resulted in a wood-based flavour that was equivalent to that of the traditionally-aged beer, despite only taking one hour instead of 6 months to produce. The traditionally-aged beer did present with certain flavours that were absent from the ultrasound-based beer, such as a richer flavour likely imparted by gradual oxidation. As a result, it is possible that the addition of a minimal amount of air or oxygen into the beer (as experienced by beer aged in a barrel) during the ultrasound treatment may impart the beer with the oxidation-based flavour that was absent from the ultrasound-based aged sample of the exemplary studies. However, the similarities in smell and flavour between the traditionally-aged beer and the ultrasound-aged beer show that ultrasound is a viable alternative to impart flavour to beer that results from aging while saving significant time that is usually required to achieve successful aging of the beer.

Although the invention has been described with reference to preferred embodiments, it is to be understood that modifications may be resorted to as will be apparent to those skilled in the art. Such modifications and variations are to be considered within the purview and scope of the present invention.

Representative, non-limiting examples of the present invention were described above in detail with reference to the attached drawing. This detailed description is merely intended to teach a person of skill in the art further details for practicing preferred aspects of the present teachings and is not intended to limit the scope of the invention. Furthermore, each of the additional features and teachings disclosed above and below may be utilized separately or in conjunction with other features and teachings.

Moreover, combinations of features and steps disclosed in the above detailed description, as well as in the experimental examples, may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

What is claimed is:

1. A method for accelerating aging of beer in order to enhance one or more flavors that are exhibited by the beer, comprising:
providing in a recipient beer with one or more materials to impart flavor to the beer during an aging process, the recipient joined to one or more ultrasonic transducers;
generating ultrasound that travel into the beer using the one or more ultrasonic transducers in order to disrupt the one or more materials contained in the beer, thereby imbuing the beer with one or more flavors corresponding to the one or more materials; and
carbonizing and bottling the flavoured beer.

2. The method as defined in claim 1, wherein the ultrasound is generated at a frequency of 20 kHz-80 kHz.

3. The method as defined in claim 1, wherein the one or more transducers include transducers that are inserted into the recipient and protected with a waterproof barrier.

4. The method as defined in claim 1, wherein the one or more transducers include transducers that are joined to an exterior surface of a wall of the recipient, in direct contact with the wall of the recipient.

5. The method as defined in claim 1, further comprising carbonating the aged beer.

6. The method as defined in claim 1, wherein the one or more materials include wood.

7. The method as defined in claim 1, wherein the one or more materials include fruit.

8. The method as defined in claim 1, further comprising introducing oxygen into the beer while the ultrasound is generated to promote micro-oxidation.

9. The method as defined in claim 8, wherein the air is introduced into the beer by disturbing the beer.

10. The method as defined in claim 1, further comprising, after the generating, filtering the beer to remove solids.

11. Beer that has been aged using the method as defined in claim 1.

12. A method for accelerating aging of beer in order to enhance one or more flavors that are exhibited by the beer, comprising generating ultrasound that travel into beer in order to disrupt one or more materials contained in the beer, thereby imbuing the beer with one or more flavors corresponding to the one or more materials.

13. A system for accelerating aging of beer in order to enhance one or more flavors that are exhibited by the beer, comprising:
one or more ultrasonics transducers for generating ultrasound that travel into beer for disrupting one or more materials contained in the beer, thereby imbuing the beer with one or more flavors corresponding to the one or more materials; and
a controller configured to generate alternating current that is converted by the one or more ultrasonic transducers into the ultrasound at a given frequency.

14. The system as defined in claim 13, further comprising a recipient for receiving the beer.

15. The system as defined in claim 13, wherein the recipient is a vat.

16. The system as defined in claim 13, further comprising a user input interface for receiving input to start or stop the generating of ultrasound when the input is received by the controller.
